(19) United States
(12) Patent Application Publication
(10) Pub. No.: US 2014/0136161 A1
(43) Pub. Date: May 15, 2014

(54) PRECISE SIMULATION OF PROGENY DERIVED FROM RECOMBINING PARENTS

(71) Applicant: INTERNATIONAL BUSINESS MACHINES CORPORATION, Armonk, NY (US)

(72) Inventors: Niina S. HAIMINEN, White Plains, NY (US); Laxmi P. PARIDA, Mohegan Lake, NY (US); Filippo UTRO, White Plains, NY (US)

(73) Assignee: INTERNATIONAL BUSINESS MACHINES CORPORATION, Armonk, NY (US)

(21) Appl. No.: 13/675,496

(22) Filed: Nov. 13, 2012

(51) Int. Cl. G06F 17/10

(52) U.S. Cl. CPC G06F 17/10
USPC 703/2

(57) ABSTRACT

Various embodiments simulate crossover events on a chromosome. In one embodiment, a number Y of positions to be selected on a simulated chromosome is determined. Y positions j₁, . . . , j_{y} on the simulated chromosome are selected. A crossover event is placed at one or more of the positions j₁, . . . , j_{y} based on Y>0. An additional number Y′ of positions j′₁, . . . , j′_{y} to be selected on the simulated chromosome is determined. Y′ additional positions j′₁, . . . , j′_{y} on the simulated chromosome are selected. An additional crossover event is placed at one or more of the additional positions j′₁, . . . , j′_{y} based on Y′>0 and a neighborhood t associated with the one or more of the additional positions j′₁, . . . , j′_{y} being free of crossover events. A set of crossover event locations is identified based on the one or more of the positions j₁, . . . , j_{y} and additional positions j′₁, . . . , j′_{y} at which a crossover event has been placed.

### BACKGROUND

The present invention generally relates to the field of computational biology, and more particularly relates to simulating progeny derived from recombining parents.

When diploid organisms reproduce, crossovers frequently occur during meiosis. Therefore, progenies do not always receive complete copies of their parents' chromosomes. Instead, the genetic material inherited from a parent is often a combination of segments from the two chromosomes present in that parent, i.e. a combination of the two haplotypes of the parent (and similarly for material inherited from the other parent). The simulation of the crossover events in a chromosome is a fundamental component of a population evolution simulator where the population may or may not be (neutral) under selection. An individual of a diploid population draws its genetic material from its two parents and the interest is in studying this fragmentation and distribution of the parent material in the progeny. Since the crossover event dominates the simulator, it defines both the accuracy of the simulator as well as ultimately controls the execution speed of the simulator.

### BRIEF SUMMARY

In one embodiment, a computer implemented method for simulating crossover events on a chromosome is disclosed. The computer implemented method includes determining, by a processor, a number Y of positions to be selected on a simulated chromosome. The simulated chromosome has a genetic length L with a crossover rate of p. Y positions j₁, . . . , j_{y} on the simulated chromosome are selected based on the determining. A crossover event is placed at one or more of the positions j₁, . . . , j_{y} that have been selected based on Y being greater than 0. An additional number Y′ of positions j′₁, . . . , j′_{y} to be selected on the simulated chromosome is determined. Y′ additional positions j′₁, . . . , j′_{y} on the simulated chromosome are selected based on the determining. An additional crossover event is placed at one or more of the additional positions j′₁, . . . , j′_{y} that have been selected based on Y being greater than 0 and a neighborhood t associated with the one or more of the additional positions j′₁, . . . , j′_{y} being free of crossover events. A set of crossover event locations on the simulated chromosome is identified based on the zero or more of the positions j₁, . . . , j_{y} and the zero or more of the additional positions j′₁, . . . , j′_{y} at which a crossover event has been placed.

In another embodiment, an information processing system for simulating crossover events on a chromosome is disclosed. The information processing system includes a memory and a processor that is communicatively coupled to the memory. A progeny simulation module is communicatively coupled to the memory and the processor. The progeny simulation module is configured to perform a method. The method includes determining, by a processor, a number Y of positions to be selected on a simulated chromosome. The simulated chromosome has a genetic length L with a crossover rate of p. Y positions j₁, . . . , j_{y} on the simulated chromosome are selected based on the determining. A crossover event is placed at one or more of the positions j₁, . . . , j_{y} that have been selected based on Y being greater than 0. An additional number Y′ of positions j′₁, . . . , j′_{y} to be selected on the simulated chromosome is determined. Y′ additional positions j′₁, . . . , j′_{y} on the simulated chromosome are selected based on the determining. An additional crossover event is placed at one or more of the additional positions j′₁, . . . , j′_{y} that have been selected based on Y being greater than 0 and a neighborhood t associated with the one or more of the additional positions j′₁, . . . , j′_{y} being free of crossover events. A set of crossover event locations on the simulated chromosome is identified based on the zero or more of the positions j₁, . . . , j_{y} and the zero or more of the additional positions j′₁, . . . , j′_{y} at which a crossover event has been placed.

In a further embodiment, a computer program product for simulating crossover events on a chromosome is disclosed. The computer program product includes a storage medium readable by a processing circuit and storing instructions for execution by the processing circuit for performing a method. The method includes determining, by a processor, a number Y of positions to be selected on a simulated chromosome. The simulated chromosome has a genetic length L with a crossover rate of p. Y positions j₁, . . . , j_{y} on the simulated chromosome are selected based on the determining. A crossover event is placed at one or more of the positions j₁, . . . , j_{y} that have been selected based on Y being greater than 0. An additional number Y′ of positions j′₁, . . . , j′_{y} to be selected on the simulated chromosome is determined. Y′ additional positions j′₁, . . . , j′_{y} on the simulated chromosome are selected based on the determining. An additional crossover event is placed at one or more of the additional positions j′₁, . . . , j′_{y} that have been selected based on Y being greater than 0 and a neighborhood t associated with the one or more of the additional positions j′₁, . . . , j′_{y} being free of crossover events. A set of crossover event locations on the simulated chromosome is identified based on the zero or more of the positions j₁, . . . , j_{y} and the zero or more of the additional positions j′₁, . . . , j′_{y} at which a crossover event has been placed.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 is shows one example of a chromosome being simulated as part of a progeny simulation process according to one embodiment of the present invention;

FIG. 3 shows a crossover existing on the chromosome of FIG. 2 at a position within a t neighborhood of a crossover placed on the chromosome as part of the simulation process according to one embodiment of the present invention;

FIG. 4 shows the chromosome of FIG. 2 after additional crossovers have been placed thereon according to one embodiment of the present invention;

FIG. 5 is a graph showing a location mapping distance d versus a recombination factor r for closed form solutions according to the Haldane and Kosambi models, and for observed data generated according to one or more embodiments of the present invention; and

FIG. 6 is an operational flow diagram illustrating one example of a process for simulating crossover events on a chromosome according to one embodiment of the present invention.

### DETAILED DESCRIPTION

### Operating Environment

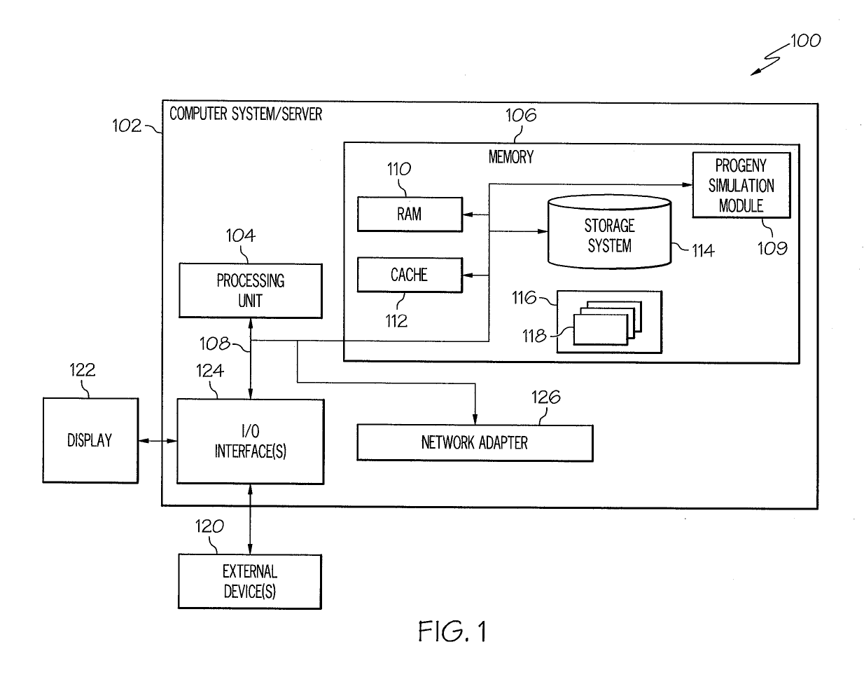

FIG. 1 illustrates a general overview of one operating environment 100 for simulating progeny derived from recombining parents according to one embodiment of the present invention. In particular, FIG. 1 illustrates an information processing system 102 that can be utilized in embodiments of the present invention. The information processing system 102 shown in FIG. 1 is only one example of a suitable system and is not intended to limit the scope of use or functionality of embodiments of the present invention described above. The information processing system 102 of FIG. 1 is capable of implementing and/or performing any of the functionality set forth above. Any suitably configured processing system can be used as the information processing system 102 in embodiments of the present invention.

As illustrated in FIG. 1, the information processing system 102 is in the form of a general-purpose computing device. The components of the information processing system 102 can include, but are not limited to, one or more processors or processing units 104, a system memory 106, and a bus 108 that couples various system components including the system memory 106 to the processor 104.

The bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 106, in one embodiment, includes a progeny simulation module 109 configured simulate crossover events on a chromosome. It should be noted that the progeny simulation model 109 can be a standalone module or be part of another simulator such as (but not limited to) a progeny simulator that is configured to simulate progeny from recombining parents. The progeny simulation module 109 is discussed in greater detail below. Even though FIG. 1 shows the progeny simulation module 109 residing in the main memory, the progeny simulation module 109 can reside within the processor 104, be a separate hardware component, and/or be distributed across a plurality of information processing systems and/or processors.

The system memory 106 can also include computer system readable media in the form of volatile memory, such as random access memory (RAM) 110 and/or cache memory 112. The information processing system 102 can further include other removable/non-removable, volatile/non-volatile computer system storage media. By way of example only, a storage system 114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 108 by one or more data media interfaces. The memory 106 can include at least one program product having a set of program modules that are configured to carry out the functions of an embodiment of the present invention.

Program/utility 116, having a set of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the present invention.

The information processing system 102 can also communicate with one or more external devices 120 such as a keyboard, a pointing device, a display 122, etc.; one or more devices that enable a user to interact with the information processing system 102; and/or any devices (e.g., network card, modem, etc.) that enable computer system/server 102 to communicate with one or more other computing devices. Such communication can occur via I/O interfaces 124. Still yet, the information processing system 102 can communicate with one or more networks such as a local area network (LAN), a general wide area network (WAN), and/or a public network (e.g., the Internet) via network adapter 126. As depicted, the network adapter 126 communicates with the other components of information processing system 102 via the bus 108. Other hardware and/or software components can also be used in conjunction with the information processing system 102. Examples include, but are not limited to: microcode, device drivers, redundant processing units, external disk drive arrays, RAID systems, tape drives, and data archival storage systems.

Progeny Simulation

In one embodiment, the progeny simulation module 109 simulates crossover events as part of a progeny simulation process. As will be discussed in greater detail below the progeny simulation module 109 takes as input a length of one or more chromosomes. For each sampled chromosome the progeny simulation module 109 draws a number of positions from a Poisson random distribution. The progeny simulation module 109 then selects a random position on the chromosome based on the number drawn from the Poisson random distribution. The progeny simulation module 109 then introduces a crossover at each position. If there exists a crossover in any of the previous t or next t positions from the selected position the progeny simulation module 109 removes the crossover that has been introduced at the selected position with a given probability. The progeny simulation module 109 then selects a given number of additional positions from a Poisson distribution. For each of the additional positions that have been randomly selected the progeny simulation module 109 introduces a crossover at that position if a crossover does not exist in the previous t or next t positions. The selected positions at which crossovers have been introduced and not removed by the progeny simulation module 109 are outputted as the locations of crossover events in the chromosome.

The following is a detailed discussion on simulating crossover events according to one or more embodiments of the present invention. A crossover hypothesis can be identified through a precise mathematical model M. For example, if rᵢⱼ is the recombination fraction between locations i and j on the chromosome, then

r₁₃=r₁₂+r₂₃+2Cr₁₂r₂₃ (EQ 1)

where locations 1, 2, and 3 appear in this order in the chromosome, and C is an interference factor. Interference refers to a phenomenon by which a chromosomal crossover in one interval decreases the probability that additional crossovers occur nearby. When C=1, the relationship between r (observable) and the map distance d between any pair of locations on the chromosome is:

$$r = \frac{1}{2} ( 1 - {e}^{- 2 d} ) \qquad ( EQ 2 )$$

when C=2r:

$$r = \frac{1}{2} tanh 2 d . \qquad ( EQ 3 )$$

However, even after identifying a crossover hypothesis through a precise mathematical model M, such as the model given above in EQ 1, many conventional simulators are unable to simulate each progeny in a manner that is faithful to the model M. Therefore, one or more embodiments provide a framework to generate crossovers based on the mathematical model of EQ 1 with a very high level of accuracy when compared to the Haldane (C=1) and Kosambi (C=2r) models. This framework handles a generic interference function of the form

C=f(r) (EQ 4).

A more detail discussion of the Haldane model is given in J. B. S. Haldane: “The combination of linkage values, and the calculation of distance between linked factors”, Journal of Genetics, 8:299-309, 1919, which is hereby incorporated by reference in its entirety. A more detailed discussion of the Kosambi model is given in D. D. Kosambi: “The estimation of map distance from recombination values”, Journal of Genetics, 12(3):172-175, 1944, which is hereby incorporated by reference in its entirety.

In one embodiment, the progeny simulation module 109 is configured with respect to the following parameters:

$$\begin{matrix}L = Z \times 100 , \\ t = \{ \begin{matrix}0 & if C = 1 ( Haldane model ) , \\ {X}_{16} & if C = 2 r ( Kosambi model ) ,\end{matrix} & ( EQ 5 ) \\ a = {X}_{1.1} , & ( EQ 6 ) \\ q = 1 - 2 p , \\ {p}^{′} = pq \frac{1 - {( 1 - p )}^{at}}{{( 1 - p )}^{at + 1}} , & ( EQ 7 )\end{matrix}$$

The parameter L is the input received by the progeny simulation module 109, and is the length of a chromosome defined as Z Morgans or Z×100 centiMorgans (cM). In one embodiment, an assumption is made that in a chromosome segment of length 1 cM there is a 1% chance of a crossover. This crossover rate is encoded as p=0.01. The parameter t is a neighborhood size of interest on the chromosome being simulated. In one embodiment, the parameter t=X_{c} and is experimentally determined to have a mean value of 16. X_{c} is a random variable drawn from a uniform distribution on [m, n] for some m<n, where c=(m+n)/2. For example, a uniform discrete distribution on [1,31] for t. The parameter a is a scaling parameter for the neighborhood size t. In one embodiment, the parameter a=X_{w} and is experimentally determined to have a mean value of 1.1. X_{w} is a random variable drawn from a uniform distribution on [y, z] for some y<z, where w=(y+z)/2. For example, a uniform continuous distribution on [1.0,1.2] for a. The parameter q is a probability that is used by the progeny simulation module 109 to decide whether to assign crossovers when other crossovers have already been assigned at locations in the neighborhood (interference). Considering the function C of EQ 4, q can be defined as defined as q=1−f(p). In this general framework a of EQ 6 and t of EQ 5 are estimated empirically to match the expected r curves of the Haldane and Kosambi models, respectively.

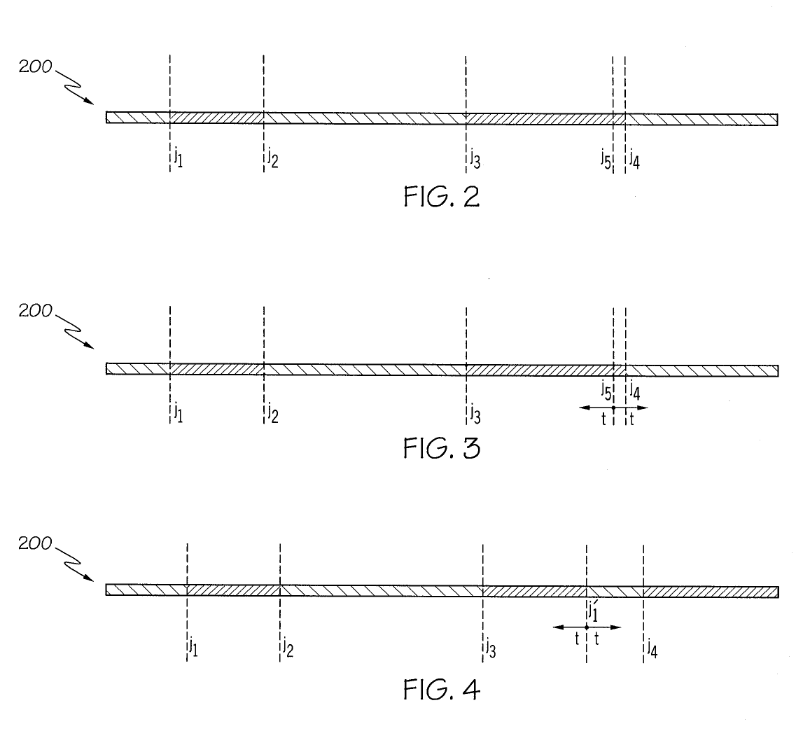

FIG. 2 shows one example of a chromosome 200 being simulated by the progeny simulation module 109 as part of a meiosis process. As discussed above, the progeny simulation module 109 takes as input a length L of a chromosome. In one embodiment, this length is defined by a user. In the current example, the progeny simulation module 109 receives from a user (or an application) a length of L=500 cM. The progeny simulation module 109, in one embodiment, also receives a selection from the user of a mathematical model, such as the Haldane or Kosambi models, on which to base the crossover simulation process on. For example, the user selects whether C=1 (no interference) or C=2r (interference).

The progeny simulation module 109 draws a number Y of positions from a Poisson distribution with mean λ=pL. In the current example Y=5, p=0.01, L=500, and 2=5. The progeny simulation module 109 randomly selects positions j₁, . . . , j_{y} from 0 to L (real numbers, not limited to integers) on the chromosome 200 based on the number Y that has been drawn. For each of the randomly selected j₁, . . . , j_{y} positions, the progeny simulation module 109 places a crossover event at the position. In the current example, this process is performed 5 times since Y=5, as shown in FIG. 2. For example, FIG. 2 shows that the crossover simulation module 109 has placed a crossover event (represented by a dashed line) at positions j₁ 202, j₂ 204, j₃ 206, j₄ 208, and j₅ 210. If the user has selected a no interference simulation (i.e., C=1) the progeny simulation module 109 outputs the locations of the crossovers on the chromosome 200. In this example, the progeny simulator module 109 outputs positions j₁ 202, j₂ 204, j₃ 206, j₄ 208, and j₅ 210 as the locations of the crossovers.

However, if the user has selected an interference simulation (i.e., C=2r) the progeny simulation module 109 considers the t cM neighborhood of a current position when placing a crossover location. For example, when placing a crossover event at position j₅ the progeny simulation module 109 determines that at least one other crossover exists in the t cM neighborhood of position j₅, as shown in FIG. 3. For example, FIG. 3 shows that a crossover already exits at position j₄, which is within the t cM neighborhood of position j₅. Therefore, the progeny simulation module 109 removes the crossover at position j₅ with probability q=0.98.

The progeny simulation module 109 draws a number of Y′ additional positions j′₁, . . . , j′_{y} from a Poisson distribution with mean λ=p′L. In the current example Y′=1,

$${p}^{′} = ( .01 * .98 ) \frac{1 - {( 1 - .01 )}^{1.1 * 16}}{{( 1 - .01 )}^{( 1.1 * 16 ) + 1}} \approx .0019$$

with a=1.1 and t=16, and λ=p′L≈(0.0019*500)=0.95. The progeny simulation module 109 randomly selects a position j′ from 0 to L (a real number, not limited to integers) on the chromosome 200 for each Y′, where Y′=1 in this example. The progeny simulation module 109 places a crossover event at this randomly selected position j′₁, as shown in FIG. 4. For example, FIG. 4 shows that the progeny simulation module 109 has placed an additional crossover at position j′₁. The progeny simulation module 109 determines if at least one other crossover exists in the t cM neighborhood of location j′₁. In the current example, no other crossover exists within the t cM neighborhood of location j′₁. Therefore, the crossover at position j′₁ is introduced on the chromosome. The progeny simulation module 109 then outputs the locations of the crossovers on the chromosome. In this example, the progeny simulation module 109 outputs positions j₁, j₂, j₃, j₄, and j′₁ as the locations of the crossovers.

In one embodiment, the crossover simulation process discussed above is also applicable to varying crossover frequency along a chromosome. For example, the crossover simulation process can be applied when dividing the chromosome into blocks with varying crossover rates. In this embodiment, the progeny simulation module 109 receives as input crossover rates p₁, p₂, . . . , p_{L} (0≦p₁<1, l=1, . . . , L) and segment lengths Z₁, Z₂, . . . , Z_{L} (Zₗ>0). Based on this input the progeny simulation module 109 outputs the locations of crossovers R. For example, for l=1, . . . , L the progeny simulation module 109 performs the crossover simulation process discussed above using parameters Z=Z₁ and p=pₗ. The progeny simulation module 109 appends crossover locations to result R. The progeny simulation module 109 outputs a concatenation of crossover positions, and the genetic length of the chromosome in cM is 100×Σₗpₗ.

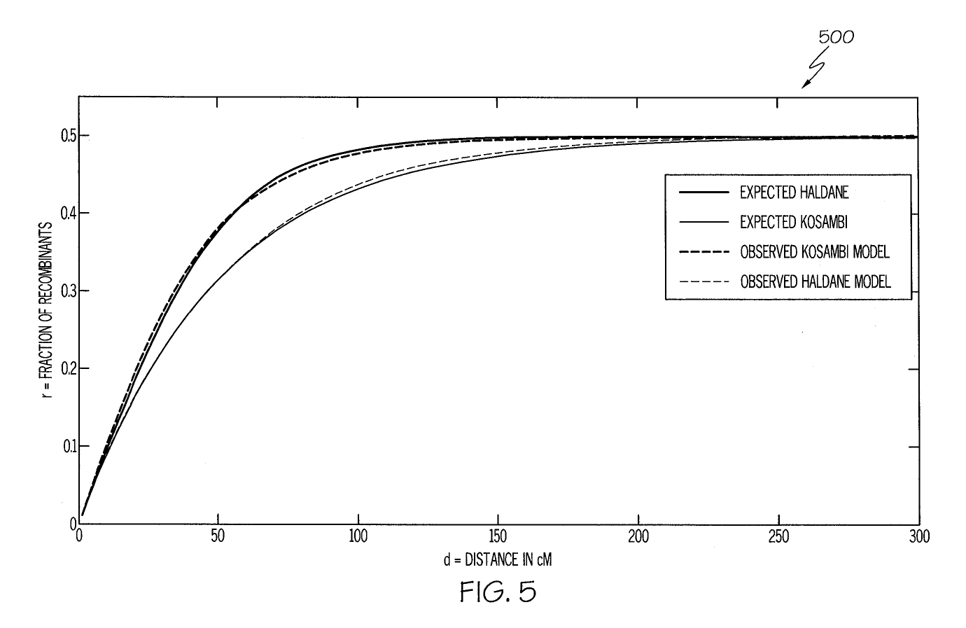

FIG. 5 shows the agreement of r from the crossover simulation process discussed above to the expected values (based on the closed form solutions). In particular, FIG. 5 shows distance d versus recombination fraction r for closed form solutions according to the Haldane and Kosambi models, and for observed data generated according to the crossover simulation process performed by the progeny simulation module 109. As can be seen, the observed data generated according to the crossover simulation process performed by the progeny simulation module 109 matches the expected values of the Haldane and Kosambi models with a very high degree of accuracy. Also, let cₚ be the time associated with a Poisson draw and cᵤ with a uniform draw. Then expected time taken by the above algorithm for each sample is O(2cₚ+(Z+1)cᵤ) in contrast to O(100Zcᵤ) for a traditional “chromosome walk” algorithm that would decide for each cM position whether to introduce a crossover or not.

Operational Flow Diagrams

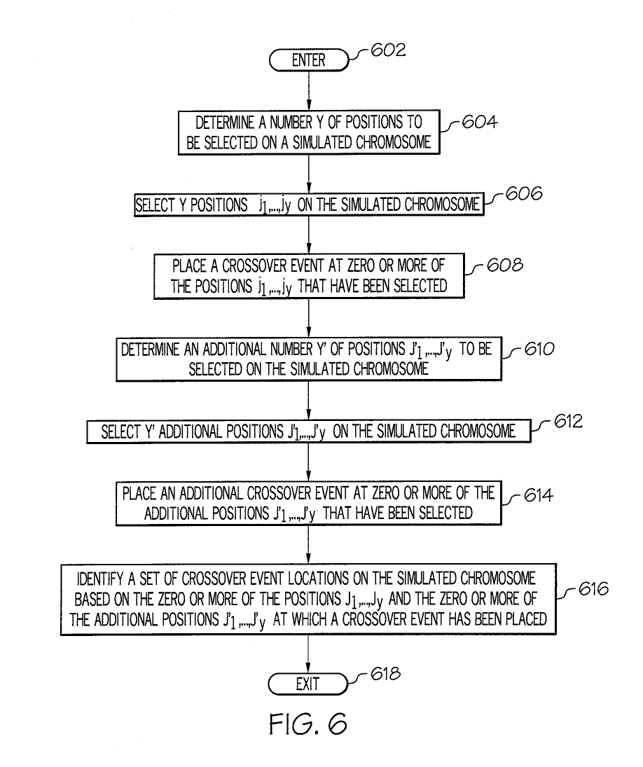

FIG. 6 is an operational flow diagram illustrating one example of an overall process for simulating crossover events on a chromosome. The operational flow diagram begins at step 602 and flows directly to step 604. The progeny simulation model 109, at step 604, determines a number Y of positions to be selected on a simulated chromosome 200. The simulated chromosome 200 has a genetic length L with a crossover rate of p. The progeny simulation model 109, at step 606, selects, based on the determining, Y positions j₁, . . . , j_{y} on the simulated chromosome 200. The progeny simulation model 109, at step 608, places a crossover event at one or more of the positions j₁, . . . , j_{y} that have been selected based on Y being greater than 0. For example, at least a first crossover event is placed at a position on the chromosome since no other crossover events current exist on the chromosome.

The progeny simulation model 109, at step 610, determines an additional number Y′ of positions j′₁, . . . , j′_{y} to be selected on the simulated chromosome 200. The progeny simulation model 109, at step 612, selects, based on the determining, Y′ additional positions j′₁, . . . , j′_{y} on the simulated chromosome 200. The progeny simulation model 109, at step 614, places an additional crossover event at one or more of the additional positions j′₁, . . . , j′_{y} that have been selected based on Y′ being greater than 0 and a neighborhood t associated with the one or more of the additional positions j′₁, . . . , j′_{y} being free of crossover events. For example, if a crossover event currently exists at one of more positions within a neighborhood t of the one or more of the additional positions j′₁, . . . , j′_{y}, a crossover event is not placed at the one or more of the additional positions j′₁, . . . , j′_{y}. However, if no crossover events currently exist within a neighborhood t of the one or more of the additional positions j′₁, . . . , j′_{y}, a crossover event is placed at the one or more of the additional positions j′₁, . . . , j′_{y}. The progeny simulation model 109, at step 616, identifies a set of crossover event locations on the simulated chromosome based on the one or more of the positions j₁, . . . , j_{y} and the one or more of the additional positions j′₁, . . . , j′_{y} at which a crossover event has been placed. The control flow exits at step 618.

### Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for simulating crossover events on a chromosome, the computer implemented method comprising:
determining, by a processor, a number Y of positions to be selected on a simulated chromosome, wherein the simulated chromosome has a genetic length L with a crossover rate of p;
selecting, based on the determining, Y positions j₁, . . . , j_{y} on the simulated chromosome;
placing a crossover event at one or more of the positions j₁, . . . , j_{y} that have been selected based on Y being greater than 0;
determining an additional number Y′ of positions j′₁, . . . , j′_{y} to be selected on the simulated chromosome;
selecting, based on the determining, Y′ additional positions j′₁, . . . , j′_{y} on the simulated chromosome;
placing an additional crossover event at one or more of the additional positions j′₁, . . . , j′_{y} that have been selected based on Y′ being greater than 0 and a neighborhood t associated with the one or more of the additional positions j′₁, . . . , j′_{y} being free of crossover events; and
identifying a set of crossover event locations on the simulated chromosome based on the one or more of the positions j₁, . . . , j_{y} and the one or more of the additional positions j′₁, . . . , j′_{y} at which a crossover event has been placed.

2. The computer implemented method of claim 1, further comprising:
determining, for at least a first of the positions j₁, . . . , j_{y} at which a crossover event has been placed, if at least one crossover event is located at a position on the simulated chromosome within a t neighborhood of the first of the positions j₁, . . . , j_{y}, wherein t=X_{c}, where X_{c} is a random variable drawn from a uniform discrete distribution on [m, n] where m<n, where c=(m+n)/2; and
removing the crossover event placed at the first of the positions j₁, . . . , j_{y} with a probability q=(1−2p) based on the at least one crossover event being located at the position on the simulated chromosome within the t neighborhood.

3. The computer implemented method of claim 2, wherein m=1, n=31, and c=16.

4. The computer implemented method of claim 1, further comprising:
determining, for at least a first of the additional positions j′₁, . . . , j′_{y} at which a crossover event has been placed, if at least one crossover event is located at a position on the simulated chromosome within a t neighborhood of the first of the additional positions j′₁, . . . , j′_{y}, wherein t=X_{c}, where X_{c} is a random variable drawn from a uniform discrete distribution on [m, n] where m<n, where c=(m+n)/2; and
removing the crossover event placed at the first of the additional positions j′₁, . . . , j′_{y} with a probability q=(1−2p) based on the at least one crossover event being located at the position on the simulated chromosome within the t neighborhood.

5. The computer implemented method of claim 4, wherein m=1, n=31, and c=16.

6. The computer implemented method of claim 1, wherein the number Y of positions j₁, . . . , j_{y} are selected from a Poisson distribution with a mean λ=pL, where p=0.01.

7. The computer implemented method of claim 6, wherein the number Y′ of positions j′₁, . . . , j′_{y} are selected from a Poisson distribution with a mean λ′=p′L, and
$${p}^{′} = pq \frac{1 - {( 1 - p )}^{at}}{{( 1 - p )}^{at + 1}} ,$$
where q is a probability equal to (1−2p), a is a scaling factor equal to X_{w}, where X_{w} is a random variable drawn from a uniform continuous distribution on [y, z] where y<z, where w=(y+z)/2.

8. The computer implemented method of claim 7, wherein w=1.1, y=1.0, and z=1.2.

9. The computer implemented method of claim 1, wherein the genetic length L comprises a plurality of segment lengths Z₁, Z₂, . . . , Z_{L} (Zₗ>0), and wherein each segment length Z₁, Z₂, . . . , Z_{L} has a corresponding crossover rate p₁, p₂, . . . , p_{L} (0≦pₗ<1, l=1, . . . , L), and wherein the set of crossover event locations is a concatenation of crossover positions placed on the simulated chromosome for each segment length Z₁, Z₂, . . . , Z_{L} based on each of the corresponding crossover rates p₁, p₂, . . . , p_{L}.

10-20. (canceled)
